(19) United States
(12) Patent Application Publication
(10) Pub. No.: US 2026/0080122 A1
(43) Pub. Date: Mar. 19, 2026

(54) SYSTEM AND METHOD FOR PERFORMING SIMULATIONS OF UNCERTAIN FUTURE EVENTS

(71) Applicant: AURORA ANN, LLC, Las Vegas, NV (US)

(72) Inventors: Craig Trivelpiece, Irvine, CA (US); Michael M. Bissonette, Irvine, CA (US); Thomas Cocotis, Irvine, CA (US); David Maeschen, Irvine, CA (US)

(21) Appl. No.: 19/396,700

(22) Filed: Nov. 21, 2025

Related U.S. Application Data
(63) Continuation of application No. 16/736,766, filed on Jan. 7, 2020, now abandoned.
(60) Provisional application No. 62/789,919, filed on Jan. 8, 2019.

(51) Int. Cl. G06F 30/20; G06F 17/18; G06F 111/10; G06N 20/00

(52) U.S. Cl. CPC G06F 30/20; G06F 17/18; G06N 20/00; G06F 2111/10

(57) ABSTRACT

A system and method for performing simulations of uncertain future events may use statistical analysis via computerized simulations associated with processes including project scheduling; project budgeting, project risk assessments (or confidence percentages), strategic decision-making of alternatives, investment alternatives, etc. In some embodiments, the system and method may utilize probability and convolution theory to arrive at ideal theoretical probabilistic solutions (PDF [probability density function] and “S” Curve [cumulative distribution function] outcomes).

### RELATED APPLICATIONS

This application claims the benefit under 35 USC 119(e) to U.S. Provisional Patent Application Ser. No. 62/789,919, filed Jan. 8, 2019 and entitled “System and Method for Performing Simulations of Uncertain Future Events May Use Statistical Analysis”, the entirety of which is incorporated herein by reference.

### FIELD

The disclosure relates generally to performing simulations of uncertain future events and in particular to performing the simulations of uncertain future events using statistical analysis.

### BACKGROUND

The advent of computer technology advancements over the past several decades has led to the proliferation (e.g. usages/methods and software applications) of computational modelling and simulation, within most industries and organizations across the world. This trend is continuing, and methods for effectively and efficiently handling more complex and challenging problems (e.g. via machine learning, artificial intelligence, better forecasting, more precise planning, managing projects with greater complexity and risk with higher levels of confidence, etc.) are constantly being sought. The building blocks (underlying technologies) for some of these advancements are in place and perched for discovery of implementations of methods which co-mingle them in new innovative ways.

Known systems and techniques use well-known “brute force” Monte Carlo simulation (computational algorithms that rely on repeated random sampling to obtain numerical results, by iteratively simulating the entire software algorithm, and displaying the results via histograms [i.e. discrete probability density functions (PDFs)] and cumulative distribution functions [i.e. “S” Curves]). One technical problem that was not solved by these known systems and methods is these known systems and methods are unable to facilitate the modelling and simulation of an IMS (Integrated Master Schedule) without the use of random number generators (i.e. unique random numbers between 0.0 and 1.0 are generated for every task in the network to arrive at a singular random solution) and in a manner that significantly speeds up the time to simulate, even with the use of random number generators. The other problem is that to obtain a legitimate statistically significant result, the known processes must perform this random number generation process numerous times (typically tens or hundreds of thousands of times—referred to as iterations), and one usually has to experiment (via trial and error) to determine the right (or optimal) number of iterations to be used in order to obtain legitimate results. These issues cause the Brute Force Monte Carlo approach to be both experimental and time-consuming. Further, the results of the Brute Force Monte Carlo approach improve (in accuracy) as the number of iterations is increased, but then the process takes longer and longer.

Thus, it is desirable to provide a system and method that provides a technical improvement to the above known technical process and that is so computationally efficient (relative to the brute force methods known in the art) that it decreases simulation times significantly irrespective of the number of iterations selected. It is further desirable to provide a system and method that eliminates the use of random number generators and iterations altogether, resulting in the theoretical solution in a fraction of the processing time. An example of the simulation speeds for the known Brute Force Monte Carlo as shown in the first two row in FIG. 10 wherein the execution times are tens (72 for example) or hundreds (505) of seconds.

### BRIEF DESCRIPTION OF THE DRAWINGS

FIG. 1 illustrates an example of an embodiment of a system for generating simulations;

FIG. 2A illustrates an example of an IMS generated by a known system;

FIG. 2B illustrates an example of a Duration's Probability Density Function generated from the IMS;

FIG. 2C illustrates an example of the simulation model from the IMS in FIG. 2A;

FIG. 2D illustrates an example of results data generated by the simulation of the IMS in FIG. 2A;

FIG. 3A illustrates a simulation method that may be executed by the system shown in FIG. 1 for combining each pair of PDFs to support subsequent pairings and the simulation is complete when all pairings are completed;

FIG. 3B illustrates a convolution simulation method whereby the same pairing process used in FIG. 3A is used, but no iterations are needed;

FIG. 4 illustrates how uncertain parameter/variables are both added and merged for an Integrated Master Schedule data example;

FIG. 5A illustrates how three or more uncertain parameter/variables are merged again using the Integrated Master Schedule example illustrated in FIG. 4;

FIG. 5B shows actual simulation results from a merge of 3 tasks that have over-lapping PDFs;

FIG. 6 illustrates two real-world examples of how convolution theory and methods apply to calculations and complex computations which include probabilistic branching, and that the results correspond to the theoretical solution set (Output PDFs and “S” Curves) which can normally only be approached when employing Monte Carlo simulation methods;

FIG. 7 illustrates further applications of the simulation method, taking advantage of the inherent commutative associative properties of convolving PDFs two at a time for various mathematical operations;

FIG. 8 illustrates how a digitally generated PDF is defined and represented on a scale of 0.0 to 1.0, where the frequency percentage of each data bin is potentially a different value;

FIG. 9 illustrates an example of a merge bias chart; and

FIG. 10 shows a comparison of the simulation speeds between a conventional Brute Force Monte Carlo method and the novel methods of the disclosed system and method.

### DETAILED DESCRIPTION OF ONE OR MORE EMBODIMENTS

The disclosure is particularly applicable to a system and method for providing simulations for Integrated Master Schedule (IMS) projects using the TriCoBi processing methods described below with each probability density function (PDFs) showing a duration of a task in the IMS and it is in this context that the disclosure will be described. It will be appreciated, however, that the system and method has greater utility, since the system and method is also applicable to other analyses (e.g. project costs, project resources, machine learning, financial markets assessments, etc.), for the inherent communitive associative properties relative to operating on PDFs (Probability Density Functions) to perform modelling and simulations which include most mathematical and logical combinations of variables—basically, any application that a “brute force” Monte Carlo Simulation can support (but with the bonus of doing so much faster and without the need for deciding upon how many iterations to choose) this disclosed system and method can as well, with the additional benefit of producing the ideal probabilistic solutions. Furthermore, each PDF may indicate a probability of risk or return of task or item and the system and method may be used for simulation using those PDFs as well.

The exemplary IMS associated with this Modelling and Simulation method is arguably the “Stress Case” (i.e. the most difficult scenario for using the TriCoBi Simulation), versus the more straight-forward and simpler mathematical calculation of random variables in a financial analysis. An IMS is a time-based schedule containing the networked, detailed tasks deemed necessary to ensure successful program/contract execution, and systems that employ IMS Modelling and Simulation for scheduling purposes sometimes referred to as Schedule Risk Analysis (SRA) tools. It is recognized by the Department of Defense* that a “realistic” IMS must adhere to certain conventions (i.e. network structure conventions) to be acceptably used for Earned Value Management (EVM) implementation and “to perform schedule analysis”.

Quasi-randomly is a term used herein to account for Monte Carlo processes that do not utilize random number generators strictly throughout the process, if such methods are employed (e.g., one could construct a discreet PDF with the exact number of occurrences for each numerical bin based on a total number of occurrences [equaling the total number of Monte Carlo iterations], and then ensure that only that number of occurrences per bin are used—think about rolling a die with six numbered dots 36 times (the number of total iterations), but you can only pull a numbered paper randomly from a bag of six 1's, six 2's, six 3's, six 4's, six 5's and six 6's; as you select these randomly out of the bag the last selection is not random at all—it is the last numbered paper—this is not a totally randomized process, but what we are referring to as indicative of a quasi-random process).

The below disclosed system and method produces the theoretical solution which is equivalent to obtaining results from an infinite number of Brute Force Monte Carlo iterations and thus is much faster and more efficient. The system and method are so computationally efficient (relative to the brute force methods known in the art) that it decreases simulation times significantly irrespective of the number of iterations selected and eliminates the use of random number generators required in known processes and iterations altogether, resulting in the theoretical solution in a fraction of the processing time.

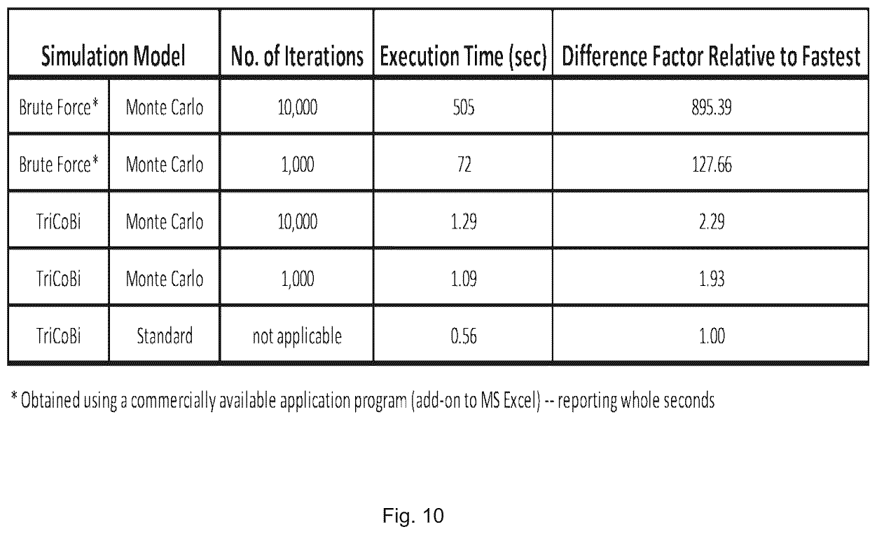

A comparison of known Brute Force Monte Carlo, TriCoBi Monte Carlo and TriCoBi Convolution (TroCoBi Standard) simulation (performed by the disclosed system and method) speeds are shown in FIG. 10. FIG. 10 illustrates the improvement of the technical process of simulating uncertain future events using the system and method disclosed below. In FIG. 10, the same complex IMS was used in all cases processed on the same computer. The Brute Force Monte Carlo results are obtained using a commercially available product (add-on to Microsoft Excel®). This data demonstrates the typical types of speed improvements that can be obtained with the two TriCoBi methods. The differences will vary with IMS complexity and iterations. It is safe to say that TriCoBi methods improve processing speeds from about 50 to 1,000 times assuming 1,000 to 10,000 iterations (and as the number of iterations increase to improve Brute Force Monte Carlo precision, the simulation processing speeds get progressively/proportionately higher, as compared to when employing either TriCoBi method).

A system and method for performing complex computational simulations are disclosed that is much faster and more precise than the standard/customary alternative—“brute force” Monte Carlo simulation described above. The novel system and method for performing complex computational simulations, the details of which are described below, provides a not well-understood, non-routine and non-conventional solution to the problem of performing complex computational simulations in the data analytics industry.

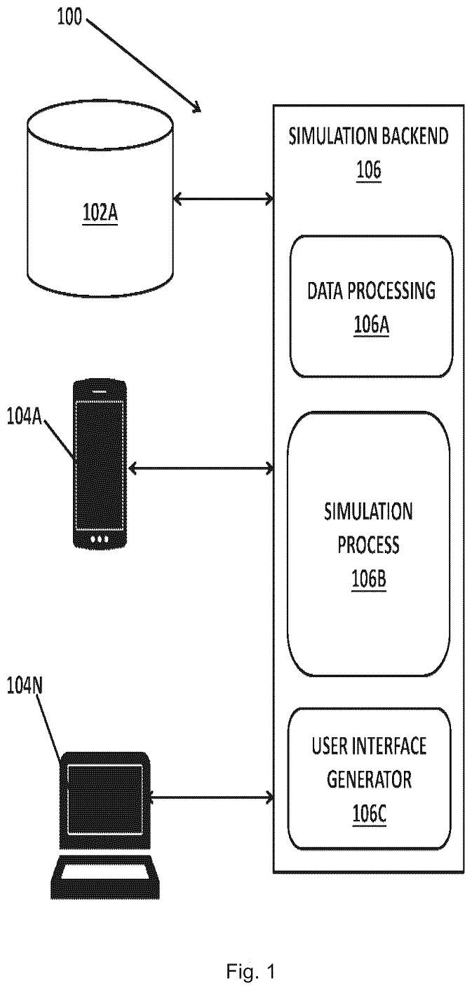

FIG. 1 illustrates an example of an implementation of a simulation system 100 that may be used for Integrated Master Schedule (IMS) projects and it is this exemplary implementation that is described below. However, the disclosed simulation system and method may be used for other analyses and projects as described above. In the data analytics industry to which this system and method may be used, the disclosed simulation method and processes are unconventional, not routine and not well understood in the industry as disclosed herein since the existing systems and methods are unable to solve the technical problem described above and achieve the results of the disclosed system.

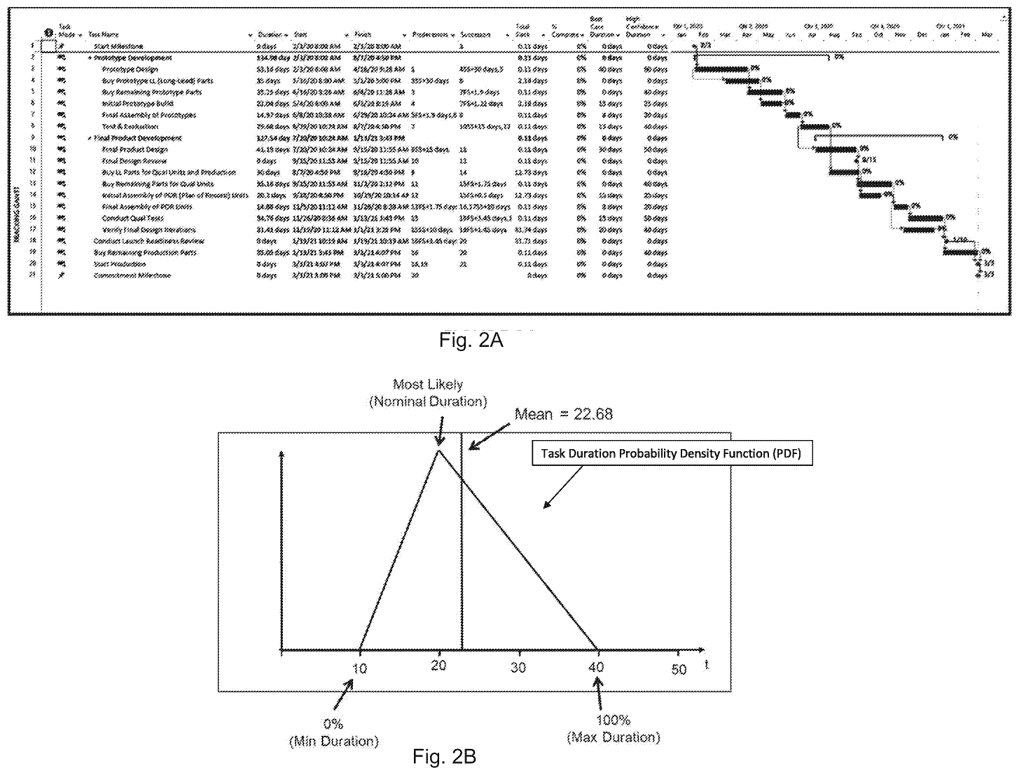

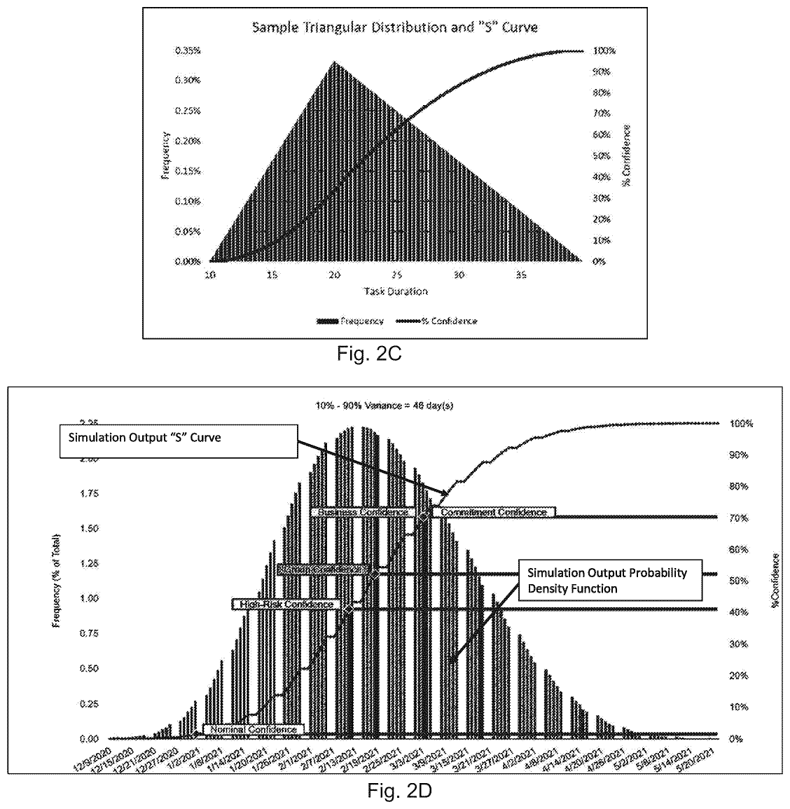

The system 100 that implements the novel process may include one or more known storage device 102A, such as a software or hardware database, that store data about the project and/or the analysis that is used an input to the simulation methods disclosed below. For example, the data may include all the network information needed to construct an IMS (i.e. example IMS generated using Microsoft Project® shown in FIG. 2A). That data can include: task Descriptions (work activities, milestones and summation bars); task Durations and their Distributions (e.g. a triangular-shaped distribution has a Minimum duration, a Nominal duration [which is the highest point and also referred to as the Mode] and a Maximum duration, and these three points define the Duration's Probability Density Function, an example of which is shown in FIG. 2B); task Inter-dependencies (predecessor and successor linkages shown with colored lines, an example of which is shown in FIG. 2A); Nominal task Start and Stop dates; Network constraints (when a Task can start and/or finish and how it affects other Tasks in the Network), etc. In addition, simulation model and results information (examples of which are shown FIGS. 2C and 2D, respectively) and their many derived statistics are stored as well. For example, FIG. 2C shows a typical task duration Triangular input distribution—which is a portion of the model and FIG. 2D shows one of many output distributions created through the simulation process for task start or finish milestones. The output is typically shown as a PDF histogram with its corresponding cumulative ascending probability function overlay, referred to as an “S” Curve (scale on right vertical axis). This curve provides the various % confidences for meeting different completion dates (shown on the horizontal axis)—for example, there is about a 70% confidence in finishing this task on or before Mar. 3, 2021 in the example shown in the figure. In another embodiment, the PDF (instead of the duration PDF shown in FIG. 2B) may be a probability of risk or return, but may have a similar shape to the PDF shown in FIG. 2B.

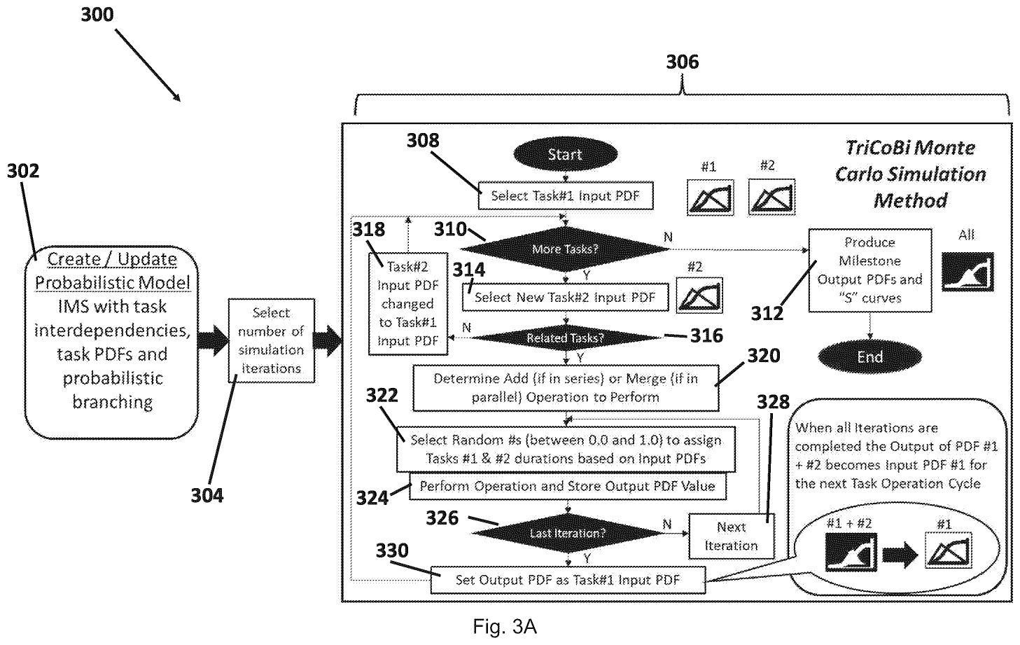

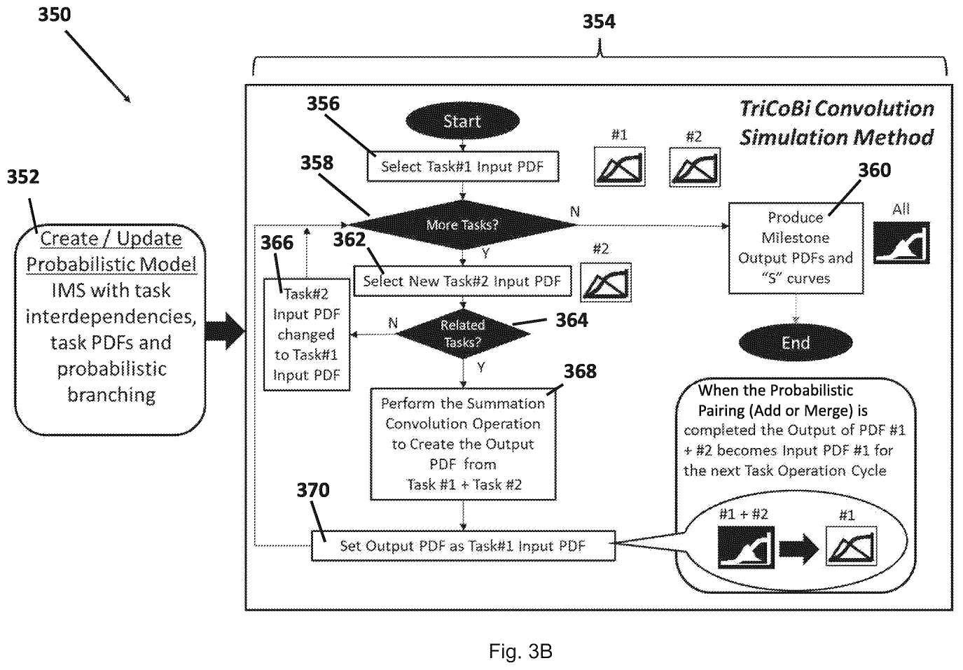

The task inter-dependencies mentioned above may be an example of a logical association through time, position or other association outside of the probability for a task. In order to do the simulation methods in FIGS. 3A and 3B, the one or more tasks have a defined relationship between the tasks so a start and end for the totals and a predecessor(s) and successor(s) for each task including time shifts or delays added. It is this relationship definition that is needed as one of the requirements for doing the full optimization. For financial modeling, the association might be a basket of stocks or money that is used in a series of transactions for optimization of reward vs risk. For Google doing optimized traffic routing on Google maps, each path from a start to an end is a linkage of street segments with path options only at intersections and knowing the PDF of traffic at a certain time of day for each street segment, the simulation method can be used to compute the critical path (fastest routine) and give the user a curve that shows the probability of getting to their destination and they could pick 70% confidence to see that they would get there in an hour or less. This method would provide real-time speed response to something that is quite time consuming now. For schedules, the association may be time and linkage, for streets it was position and linkage, for financial it may be a resource linkage such as money. There are other process flows in the industrial or supply chain arena that could benefit from this as well.

The system 100 may further include one or more computing devices 104, such as (but not limited to) a smartphone 104A, . . . , and a desktop or laptop computer 104N, that may be used by a user, for example, to access the system, interact with the system, submit data about a project or analysis or receive a user interface display from the system with the results of the novel simulation performed by the system. Each computing device 104 may be a processor-based device with at least memory, a display and/or other Input/Output (I/O) capability and thus may be the smartphone device 104A, such as an Apple iPhone device or Android operating system based device, a terminal device, the laptop computer device 104N or any known or yet to be developed computing device that can access the system as described below. The system may also include a backend system 106 wherein the storage devices 102A and computing devices 104 may connect to the backend system 106 over one or more wireless or wired networks (or a combination thereof). While the systems 102A, 104A, 104N and 106 shown in FIG. 1 are known computer systems, storage and networks, the backend system 106 stores and a processor of the backend system 106 executes a plurality of lines of computer code and the processes performed by the systems 102A, 104A, 104N and 106 with the plurality of lines of computer code (the simulation operation) are unconventional, not well understood and not routine and provide an ordered combination of processes that form an inventive concept to perform the simulation. It should be noted that the simulation process may also be implemented using hardware devices.

The backend system 106 may be implemented using one or more computing resources, such as blade servers, server computers, storage devices, web servers, application servers, cloud-based assets and the like that host and execute the plurality of lines of computer code that perform the novel and unconventional simulation process. For example, the backend 106 may include a data processing element/component 106A (that may be implemented as a plurality of lines of computer code) that may process the project/analysis data so that the data may be used in performing the simulation. The backend system 106 may further include a simulation element/component 106B (that may be implemented as a plurality of lines of computer code) that receives the data about the project/analysis and using the simulation process, described below in more detail, generates data about the simulation based on the received data. The backend 106 may further comprise a user interface generator 106C (that may be implemented as a plurality of lines of computer code) that may generate a user interface that conveys the simulation for the project/analysis to the computing devices 104 and/or to the storage device 102A.

The simulation system and method provides two technical solutions to the data analytics industry that are unconventional, not routine or well known in the data analytics industry. First, unlike traditional “brute force” Monte Carlo approach of iterating entire calculations numerous times (by systematically assigning unique random numbers to each variable parameter within the computation), the disclosed simulation method and system implements a process of sequentially performing Monte Carlo simulations on each pair of data (two probability density functions at a time), yielding a new PDF (probability density function) to add to and/or merge with the next, until the entire calculation is complete. This avoids the parabolic function of time (to compute) a result relative to the number of random variables and enables the execution time (to compute) to be more of a linear function, speeding up simulation execution time significantly, resulting in greater benefit for the more complex models being simulated.

The second technical solution provided by the disclosed simulation system and method is a process using the same method explained above, but instead of using Monte Carlo, using convolution theory (a mathematical operation on two functions f and g, producing a third function that is typically viewed as a modified version of one of the original functions, giving the integral of the pointwise multiplication of the two functions as a function of the amount that one of the original functions is translated) to yield greater computational accuracy (i.e. the ideal solution) and even greater computational speed (e.g. seconds or fractions of a second versus minutes, or hours—depending on the size of the model being simulated and the number of iterations used in the comparable Monte Carlo simulation). Convolution theory usage is enabled due to the recognition that one can perform the simulation by adding and/or merging, etc. two probability density functions at a time. This is basically akin to the commutative associative property of addition (whereby commutative relates to the order of the parameters being operated upon [e.g. a+b=b+a] and per Crewton Ramone's House of Math, associative is defined as “When three or more numbers are added, the sum is the same, regardless of the order of addition” [e.g. (a+b)+c=a+(b+c)]). This also leads to the ability of performing other more complex mathematical operations (i.e. subtracting, multiplying, dividing, etc.) to facilitate the simulation of numerous potential models based on random/probabilistic variable parameters.

The two technical solutions are game-changing for the fact that they speed up very time-consuming calculations. The convolution method takes this further since it is faster and provides the ideal theoretical solution versus the Monte Carlo method which requires a greater number of iterations to improve upon accuracy—but will not necessarily ever attain the result, precisely. The two methods can be used wherever Monte Carlo simulation methods are used.

The method disclosed below may be implemented using the system shown in FIG. 1, but may also be implemented in other manners that are within the scope of the disclosure. The method for simulation is an ordered combination of processes that achieves and not well understood, unconventional and not routine solution to the technical problem of described above. The details of the simulation method are not well understood, unconventional and not routine solution. The novel simulation method provides a technical solution and thus facilitates the modelling and simulation of an IMS (Integrated Master Schedule) with variable task duration parameters (i.e. duration Probability Density Functions (PDFs)). The disclosed method systematically convolves two PDFs at a time and yields (after repeated convolving of resultant PDFs [referred to as Output PDFs] with related [i.e. those in series or in parallel] PDFs one pair at a time) the ideal theoretical simulation result with no Monte Carlo simulation ITERATIONS needed. The disclosed simulation method was compared against conventional Monte Carlo simulation results (including that of a commercially available/licensed Monte Carlo simulation) which validate that the method is indeed sound. The test results showed that the conventional Brute Force Monte Carlo simulation results got closer and closer to the novel convolution results as the number of iterations were increased—which is as expected. The novel method however provided the ability to add PDFs sequentially (i.e. the distribution result of two PDFs convolved and then added to a third) and verified that the answer is the same regardless of order and the result closely matched the two Monte Carlo simulation results. The method also may be used for convolving merged tasks within an IMS (i.e. tasks that are performed in parallel and share at least one of the same successors). Complex schedules were tested to verify the accuracy of the Convolution results relative to the Brute Force Monte Carlo simulation results and conclude that the convolution process is indeed sound. The novel method also greatly reduces the overall processing time (using the same number of simulation iterations as a conventional method.) Before disclosing the novel method, a traditional simulation method is described and thus contrasted with the novel simulation method.

In a traditional Brute Force Monte Carlo simulation method, a number of iterations of the simulation must be performed to achieve a result. The actual number of iterations is determined by trial-and-error and the number may be 1,000+ iterations. As an example, for complex projects with many variable task durations, to get the requisite accuracy one might have to use 100,000 or 1,000,000 iterations. Thus, the simulation execution time can typically extend from a few seconds (very simple) to several hours (very complex). The traditional Monte Carlo method simulates the entire model through each iteration. In contrast, as described below, the novel simulation method shown in FIG. 3A simulates pairs of PDFs (as many times as iterations) and progresses toward a complete calculation of one pair of PDF convolution computations at a time, culminating as a complete simulation at the end of the last pairing. In an alternative novel simulation method shown in FIG. 3B, the method does not use iterations, has no random number generation and uses Convolution (of two Input PDFs) methodology versus Monte Carlo methodology. Note that in both of the novel method options (FIGS. 3A and 3B), once an Output PDF is created (from two Input PDFs) it then becomes the Input PDF for another potential pairing.

FIG. 3A illustrates a simulation method 300 that may be executed by the system shown in FIG. 1 for combining each pair of PDFs to support subsequent pairings and the simulation is complete when all pairings are completed using a Monte Carlo simulation. This method may be performed by the system shown in FIG. 1, but may also be performed using other systems, both hardware and software based. Furthermore, the method is illustrated using Integrated Master Schedule (IMS) data as an example, although the method may be used with any process that would otherwise use a traditional Monte Carlo simulation process.

In the simulation method 300, a probabilistic model may be created or updated (302) that in the illustrative example is an IMS with task interdependencies, task PDFs and probabilistic branching (an example of which is shown in FIG. 2A.) The method may then select a number of simulation iterations (304). The number of iterations typically increases with the size of the IMS schedule (i.e. number of tasks included) to get a good/representative distribution of points to make up the output PDF (and resultant ‘S Curve’)—these typically range from 1,000 to 1,000,000 and some systems have inherent data storage limits which prevent greater iterations. For each task in the network a unique random number (between 0.0 and 1.0) is generated to determine its duration value for that iteration—when all the task durations are assigned for that iteration the simulation end-point (typically a date for the completion of the project) is stored, then on to the next iteration. Once all iterations are performed the output distribution histogram is completed and the ‘S Curve’ (or cumulative probability function) can be interrogated.

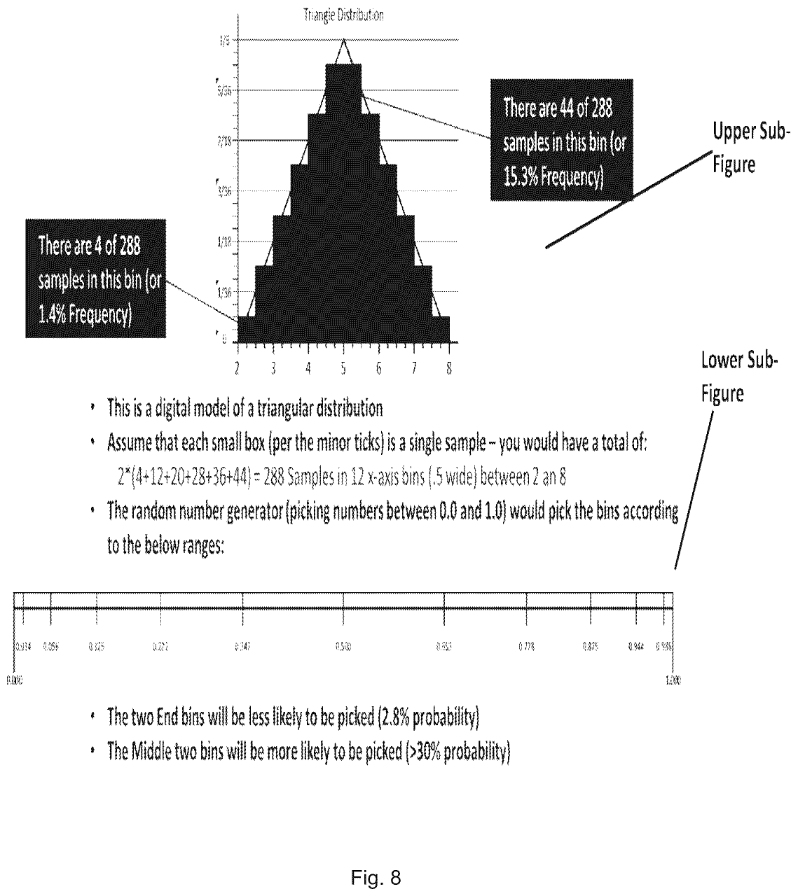

In the example in FIG. 3A, two input PDFs are being used as input to the simulation method 300 and a unique Monte Carlo simulation process 306 is performed. The method may then select Task #1 input PDF (308). Simple examples of what the data for a Task PDF looks like are provided in FIGS. 2D and 8. The method then determine if there are more tasks (more input PDFs for simulate) (310) and produces milestone output PDFs and “S” curves (312) as outputs to the simulation if only Task #1 is being simulated. An example of the milestone output PDF and ‘S’ curve are shown in FIG. 2D.

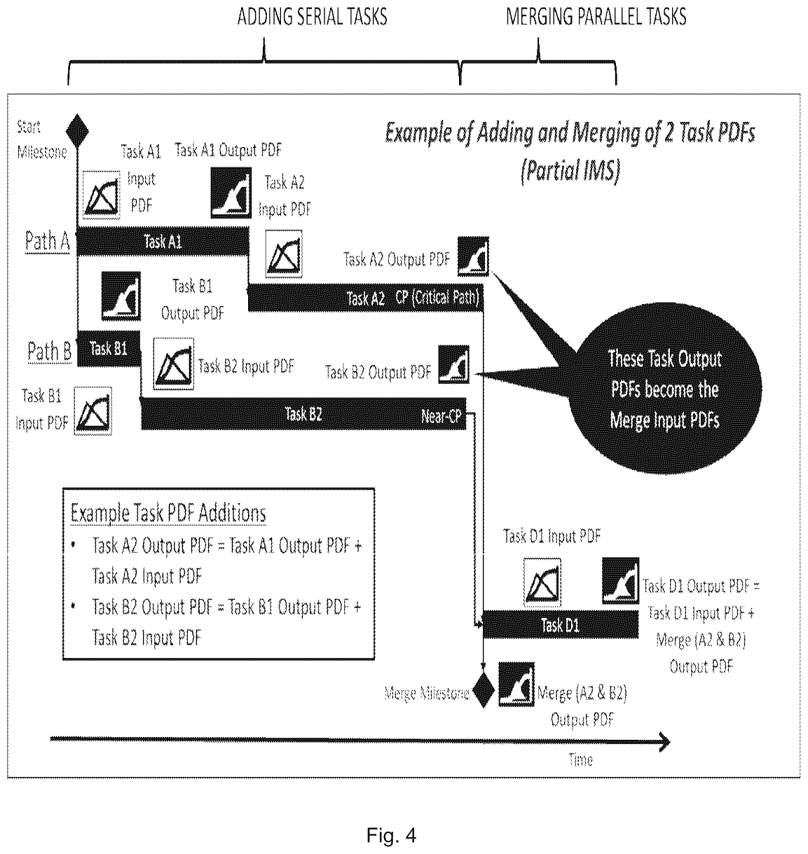

If there are more tasks, the method selects a new task #2 Input PDF (314) and then the method determines if there are any related tasks (316). The tasks are related in the IMS via interdependent network connections defined by predecessor or successor relationships (i.e. they are directly linked together and are either impacted by or impact another as a result). If there are no more related tasks to that specific task, then the method changes Task #2 PDF to Task #1 PDF (318) and checks for more tasks (i.e. new related tasks for that new #1 PDF). If there are related tasks, the method determines whether an Add operation (if the tasks are in series, for example such as tasks A1 and A2 or B1 and B2 in FIG. 4 in which the first task A1 is completed or has to be completed before the second task) or a merge operation (if the tasks are in parallel, for example such as tasks A2 and B2 in FIG. 4 in which the two tasks may occur at the same time) to perform (320). The method may then select random numbers (between 0.0 and 1.0) to assign to task #1 duration and task #2 duration based on the input PDFs (322) and then perform the determined operation that may be an add or a merge operation and store an output PDF value (324).

FIG. 8 shows how the duration values are selected based on the random number provided. For example, if the random number is 0.3567, the duration value from the bottom sub-figure in FIG. 8 would be 4.75 days (the center of the sixth duration bin from the left, which includes all random numbers between 0.347 and 0.500). The idea is that there are more random numbers for the higher bins, thus if one plotted the selections after many thousands of numbers were selected, a distribution with this shape in FIG. 8 would emerge.

Once the output PDF value is determined, the method determines if the last iteration of the method has been performed (326) based on the selected number of iterations. If the last iteration has not been performed, then the next iteration (328) is performed and the method loops back to the selection of the random numbers process 322. If the last iteration has been performed, then the method sets the output PDF as the next Task #1 Input PDF (330). As an example, in FIG. 4, the Task A1 Output PDF is added to the Task A2 Input PDF to yield the Task A2 Output PDF, which is then merged with the Task B2 Output PDF to yield the Merge (A2 & B2) Output PDF, which is then added to the Task D1 Input PDF to yield the Final Output PDF. As a result of the method 300, when all of the iterations are completed, the output of PDF #1 plus PDF #2 becomes input PDF #1 for the next task operation cycle. The various processes that are performed during the method (that are unconventional, not routine and not well understood in the industry) are the two PDFs being combined (added or merged) at a time versus selecting random numbers for all PDFs to create the end distributions. All prior methods select random numbers for every task PDF to get the results. This method of selecting random numbers for two related PDFs and building an Output PDF over the iterations, then continues the two by two process (for all iterations) until the end distributions are developed, as shown in FIG. 3A. The primary benefit is improved inherent accuracy (due to the fact that accuracy is achieved with fewer iterations than Brute Force Monte Carlo methods, especially as the number of tasks increases) in less processing time.

FIG. 3B illustrates a convolution simulation method 350 whereby the same pairing process used in FIG. 3A is used, but no iterations are needed, and mathematical convolution is used instead of Monte Carlo. This method may be performed by the system shown in FIG. 1, but may also be performed using other systems, both hardware and software based. Furthermore, the method is illustrated using—IMS data, although the method may be used with any process that would otherwise use a traditional Monte Carlo simulation process.

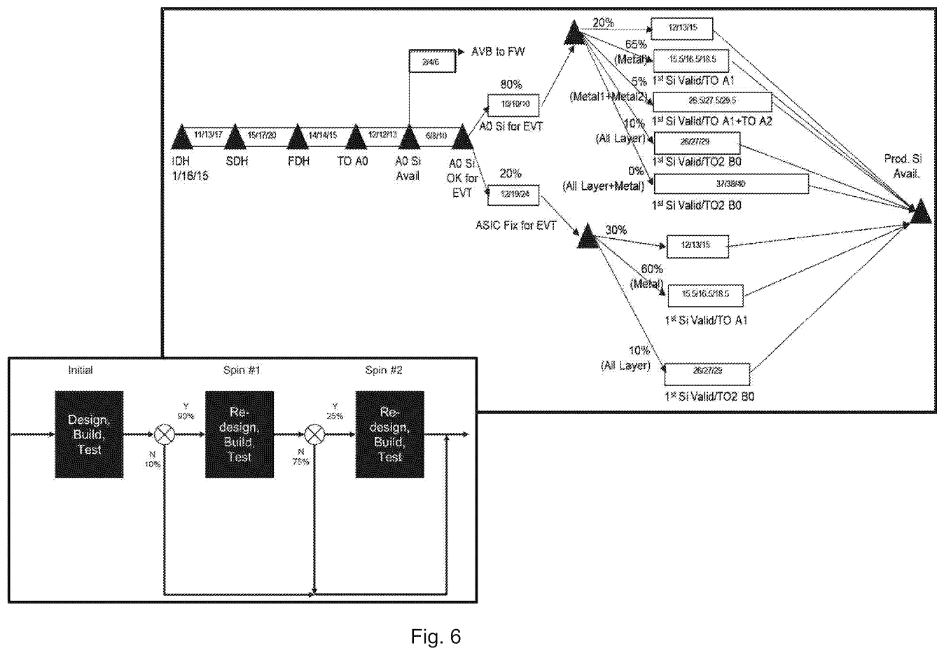

In the simulation method 350, a probabilistic model may be created or updated (352) that in the illustrative example is an IMS with task interdependencies, task PDFs and probabilistic branching (examples of which are shown in FIGS. 2A and 6, respectively.) In the example in FIG. 3B, two input PDFs are being used as input to the simulation method 300 and a unique analytical convolution simulation process 354 is performed. The method may then select Task #1 input PDF (356). The method then determines if there are more tasks (more input PDFs for the simulation) (358) and produces milestone output PDFs and “S” curves (360) as outputs to the simulation if only Task #1 is being simulated.

If there are more tasks, the method selects a new task #2 Input PDF (362) and then the method determines if there are any related (or inter-dependent) tasks (364). If there are no related tasks, then the method changes Task #2 PDF to Task #1 PDF (366) and checks for more tasks (358). If there are sequential related tasks, the method performs a summation convolution operation to create an output PDF from Task #1+Task #2 (368). Convolution is the process of combining two PDFs probabilistically by putting one distribution on an x-axis (like shown in FIG. 2C) as the reference PDF (order does not matter—either one can be the reference), then sliding the second distribution from left to right until the two PDFs touch, then continuing to slide the second PDF (overlapping the second) and continuously combining (e.g. adding or integrating) the area of the over-lapping sections together to create a third PDF (the output PDF). Once there is no more over-lap, and the second PDF slides past the first, the resultant output PDF is completed. As a result of the method 350, the output of PDF #1 and #2 becomes input PDF 1, as depicted in FIG. 4. The various processes that are performed during the method (that are unconventional, not routine and not well understood in the industry) are shown in FIG. 3B. The primary benefit is improved inherent accuracy (due to the fact that this method yields the theoretical solution and Monte Carlo methods can only approach the theoretical by increasing the number of tasks increases) in less processing time.

FIG. 4 illustrates how uncertain parameter/variables are both added and merged for an IMS data example. This illustration pertains to an IMS example but can theoretically apply to any such complex mathematical model that uses Monte Carlos methods to arrive at probabilistic solutions. The following bullets describe the addition and merge processes developed to solve such complicated problems by operating on two numerical PDFs at a time. One major premise is that this methodology follows the underlying commutative associative properties in other mathematical functions, like addition and multiplication of numbers.

More particularly, FIG. 4 depicts two schedule paths (A and B) whereby their tasks are essentially being performed in parallel and both paths ultimately merge into a successor task, D (i.e., the effort in both paths A and B must be complete to start task D). When task durations have risks and/or opportunities relative to the actual time it will take to complete them, they can be modelled as PDFs. For example, an Engineer can estimate the time to design a new electronic circuit board for a mobile phone to take him/her 20 work-days based on past experience—yet if asked what the best-case duration would be, he or she might reply that if it works fine on the first try it could take as little as 10 work-days (but this is a very unlikely opportunity)—and if asked what the highest-confidence duration would be, he or she might reply that if more design iterations are needed due to the uncertainty (i.e. risk) of the new technology, it could take up to 40 work-days. One could then model this range of estimates as a triangular-shaped PDF as shown in FIG. 2C.

Even if the task duration estimate is very well defined and accurate (i.e. a single number), it is still a PDF of 100% of the time being that value, thus this PDF flow is applicable to all tasks in the schedule network. The way this method works is by operating on two task PDFs at a time. As can be seen, each task (with the example in FIG. 4 having Tasks A1, A2, B1, B2 and D1) has an Input PDF (blue colored icon or Task A1 Input PDF and Task B1 Input PDF) and an Output PDF (green colored icon or Task A1 Output PDF, etc.).

When the input of the task has no predecessor containing a distribution (e.g. a Start Milestone) the Task output PDF is equivalent to its input PDF (e.g. in FIG. 4 Task A1's output PDF is the same as Task A1's input PDF, and Task B1's output PDF is the same as Task B1's input PDF.) The output of subsequent tasks (e.g., Task A2 output PDF) is calculated by adding (process 320-324 in FIG. 3A) (or convolving using process 368 in FIG. 3B) Task A1's output PDF with Task A2's input PDF and similarly Task B2's output PDF is determined by adding or convolving Task B1's output PDF and Task B2's input PDF. This process of continuously adding two distributions is repeated throughout the entire schedule chain, as appropriate (i.e., until an end milestone's dependencies are all accounted for). Note that since the above tasks are in series, the adding operation for the Monte Carlo method in FIG. 3A is used for each calculation.

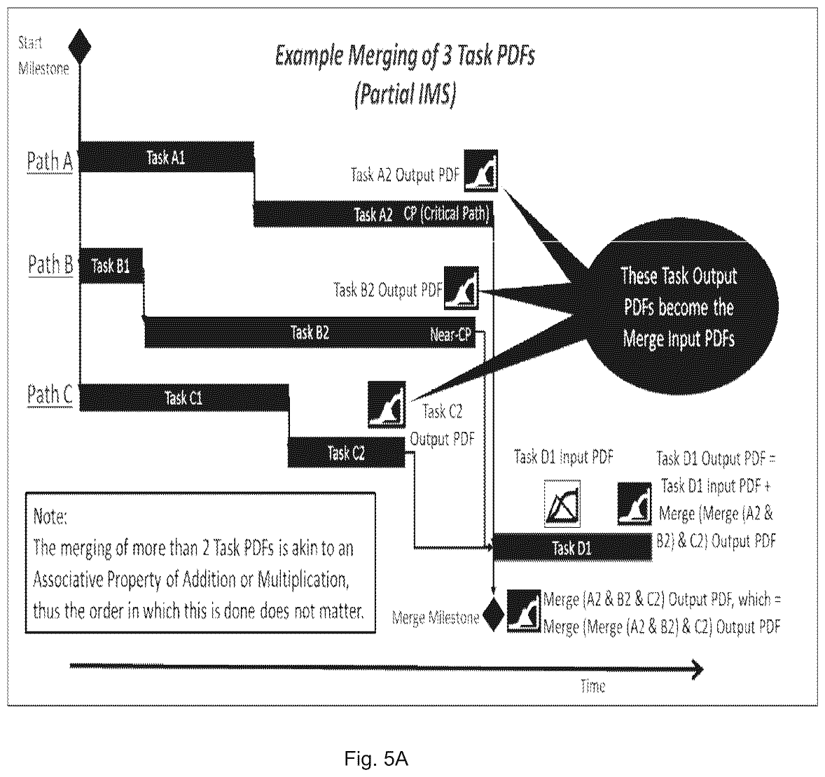

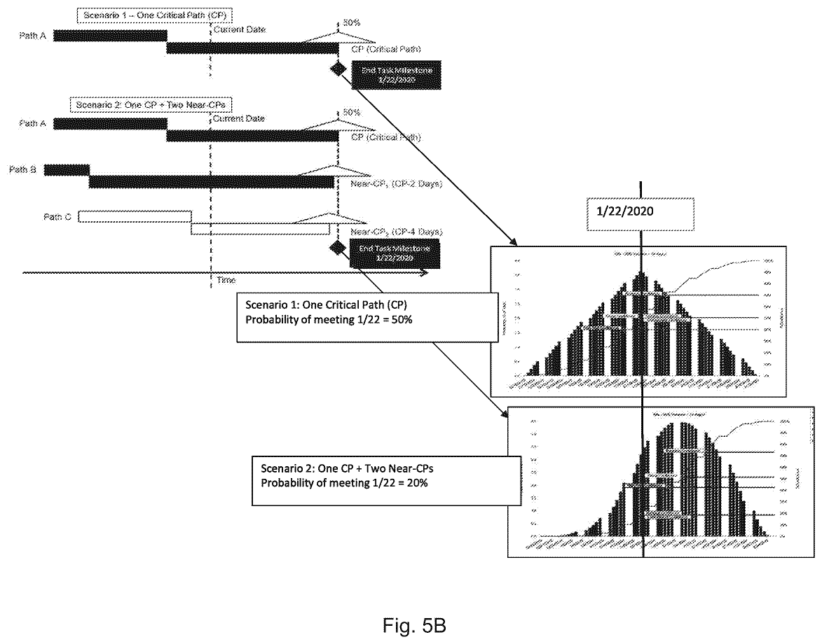

FIGS. 4 and 5B show a critical path which is important when merging happens. In particular, at least one task drives the schedule (i.e. is on the Critical Path) and other tasks that are performed in parallel have “slack” which alludes to those tasks being “Near-Critical Path”. If their slack is such that their duration PDF does not overlap the Critical Path task's PDF they do not impact the results, but if they do overlap the results are indeed impacted.

FIG. 4 also depicts the process by which the two schedule paths (A and B) merge into task D1 since Task A2 output and Task B2 output are parallel and the merge input PDFs. The two merging paths are detected by the algorithm and their output PDFs are merged (i.e. convolved in a different way than when summed). The resulting merge output PDF is then used as the PDF that the next task (in this case, Task D1) that is probabilistically combined with (a la the summation convolution process in FIG. 3B). For example, if one group of design engineers is working on the electronic circuit board for a new product, and at the same time another group is creating the software to run on that circuit board, the two activities are synchronized as much as possible and their results merge together when the System Engineers start performing Design Integration—add in a Mechanical design piece as well and you have three efforts merging into the System Engineering Design Integration task (the various tasks typically will not conclude at the exact same time, and the one that concludes last drives the Critical Path). Thus, the Output PDF of Task D1 is the addition of the Merge Output PDF (from Tasks A2 and B2) with the Task D1 Input PDF. Without the ability to mathematically/probabilistically merge tasks in parallel, as shown in FIGS. 4 and 5a, this new method would not be conceivable for Schedule Risk Analysis modelling and simulation. Adding PDFs is very simple, but “merging” them is not, and this function must be accommodated for such an innovative method to be viable for this type of application. The TriCoBi method indeed accomplishes this, thus making the overall method and its benefits not only feasible, but extremely valuable to the user community. The processes shown in FIGS. 3A and 3B achieve the same process, but are done in a different way, yielding slightly different results and in different amounts of time. However, both are significantly better than Brute Force Monte Carlo methods used today as detailed in FIG. 10 in terms of both accuracy and processing time.

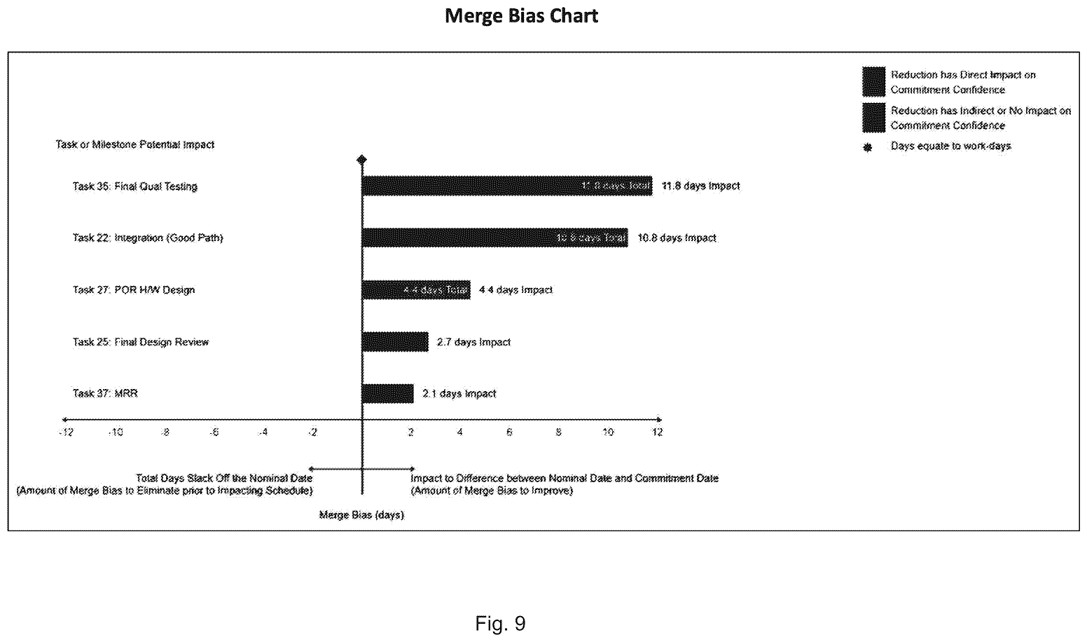

FIG. 5a illustrates how three or more uncertain parameter/variables are merged again using the Integrated Master Schedule example illustrated in FIG. 4. One of the keys to the disclosed method is that the communitive associative property of mathematical functions (like addition and multiplication) applies to the addition and merging of PDFs via probabilistic and convolution methods as well, and both methods (shown in FIGS. 3A and 3B) can be validated against the “brute force” Monte Carlo method results (which are generally accepted as valid throughout the world). This relatively simple expansion of known algorithms has not been combined and/or validated as a method until now, and as a superior methodology to employ (from both processing time and accuracy standpoints) versus the “brute force” Monte Carlo methodology. Although FIG. 5a shows the merging of only 3 uncertain parameters (or variables) represented by their PDFs, it applies equally to merging of any greater number of merges as well. FIG. 5B shows actual simulation results from a merge of 3 tasks that have over-lapping PDFs—in this case the single output is compared with a similar network, but with two other tasks whereby PDFs overlap. The % confidence output on the Oct. 28, 2015 date for Scenario 1 should be 50% and it is. The % confidence output of scenario 2 is 20% (much less than 50%, which can surprise people to learn—it is referred to as “Merge Bias”. The other novel innovation and benefit derived from the convolution method of determining Merge Bias is that the Merge Bias amount can be quantified and displayed for added SRA (Schedule Risk Analysis) consideration—the task network merges with the most impact on the network can be graphically depicted as shown in FIG. 9 to help users identify additional areas of schedule improvement (i.e. schedule reduction of compression), and their quantitative impacts.

FIG. 6 illustrates two real-world examples of how convolution theory and methods apply to calculations and complex computations which include probabilistic branching, and that the results correspond to the ideal solution set (Output PDFs and “S” Curves) which can normally only be approached when employing Monte Carlo simulation methods. The basic idea is to evaluate and comprehend discreetly characterized probabilities of future event milestones in a way that factors such possible eventualities into the process (e.g. schedule expectations and certainty, strategic decision-making alternatives, etc.)—a process which typically gets exponentially harder to assess as the number of potential paths increases. This is the type of process by which Monte Carlo simulations are prevalently used, however, the use of a valid convolution-based approach has not been formulated and offered for use until now. The illustrations provided within FIG. 6 are examples of such probabilistic branching. The diagram in the lower left-hand corner depicts a somewhat standard process in many development projects, whereby the number of additional processes (i.e. “spins”) in an iterative type of product development process is unknown until a future event occurs. To do this analysis discretely, a method may pick the path that is most likely to occur. To do this analysis probabilistically, the method generates a percentage confidence (i.e. “S” Curve value) in meeting a date and then utilize this knowledge to make a more informed decision (e.g. customer commitment, factory launch, etc.). The larger diagram shows the numerous paths that one might have to consider when developing a complex integrated circuit design for a computer chip. Many paths are possible, and you either bet on one (which typically leads to either being very aggressive or very conservative) or determine the percentage confidence (via an “S” Curve analysis) to determine your answer using the methods as shown in FIGS. 2C and 2D.

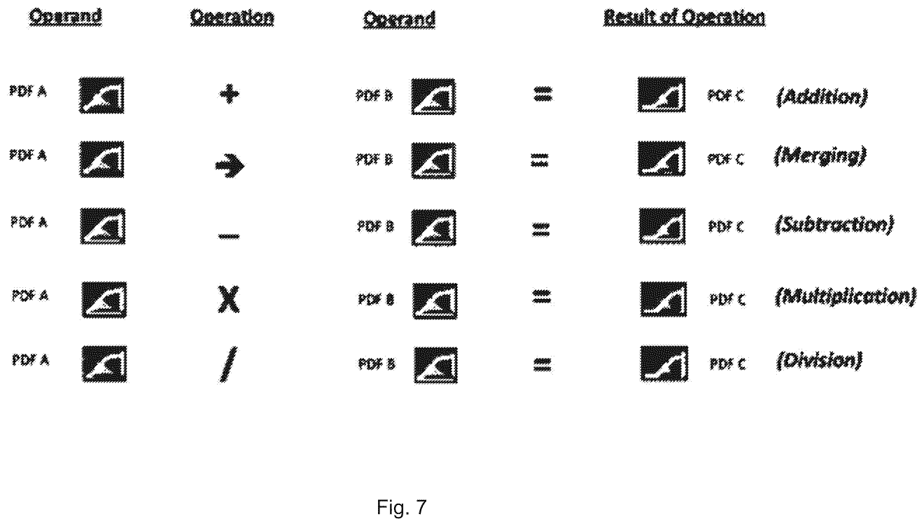

FIG. 7 illustrates further applications of the simulation method, taking advantage of the inherent commutative associative properties of convolving PDFs two at a time for various mathematical operations. This methodology applies not only to adding and merging, but to other mathematical operations, e.g. subtracting, multiplying, dividing, etc. The advent of these operations in conjunction with Convolution Theory leads to a multitude of potential applications for producing probabilistic results from the simulations of complex formulas/algorithms containing uncertain variables and probability paths. For example, any mathematical calculation using a computerized Spreadsheet performs these various mathematical operations, and although the method may use discrete numbers (i.e. a PDF with one bin) for these operations (and the method does most of the time), certain applications (e.g. project budget projections, stock market analysis, expected number of Agile process Sprints, sports odds, casino game odds, weather patterns, population demographic preferences, insurance premium determinations, political outcomes, etc.) can necessitate more complex PDF interactions which result in probabilistic outcomes (i.e. cumulative probability functions or ‘S’ curves) generated to facilitate key decisions, using a system that employs Monte Carlo and/or novel TriCoBi modelling and simulation techniques disclosed herein. Since the novel TriCoBi Standard method yields the theoretical result without the necessity of determining the most appropriate number of simulation iterations to use, and the TriCoBi method's inherent processing speed advantage, these decisions can be made more accurately and expediently since all mathematical functions are accommodated by this fundamental innovative method.

FIG. 8 illustrates how computer-generated Probability Distribution Functions are set up. This is a relatively simple equilateral triangular distribution that digitally represents an analog function. The number of bins is dependent on desired resolution of the data—e.g. the smaller the bins the finer the resolution. In this case there are 288 Samples of data across 12 bins. For example, the left-most bin has 4 samples, meaning that there is a 4/288=1.4% chance of the value 2.25 (center of the bin) to be selected randomly—and the bin that is 6^{th} from the left (centered at 4.75) has a 44/288=15.3% chance of being randomly selected. The bottom sub-figure shows the random number ranges (between 0.0 and 1.0) that the computer uses to randomly pick the various values (e.g. the 6^{th} value from the left of 4.75 would be picked for all random numbers between 0.500 and 0.653. If you picked 10,000 random numbers between 0.0 and 1.0 you would get a distribution that looks like the top sub-figure.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the disclosure and various embodiments with various modifications as are suited to the particular use contemplated.

The system and method disclosed herein may be implemented via one or more components, systems, servers, appliances, other subcomponents, or distributed between such elements. When implemented as a system, such systems may include an/or involve, inter alia, components such as software modules, general-purpose CPU, RAM, etc. found in general-purpose computers. In implementations where the innovations reside on a server, such a server may include or involve components such as CPU, RAM, etc., such as those found in general-purpose computers.

Additionally, the system and method herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the system and method may be achieved via or performed by logic and/or logic instructions including program modules, executed in association with such components or circuitry, for example. In general, program modules may include routines, programs, objects, components, data structures, etc. that perform particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

The software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules and/or other components. Further, communication media may include wired media such as a wired network or direct-wired connection, however no media of any such type herein includes transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, features consistent with the disclosure may be implemented via computer-hardware, software and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though again does not include transitory media. Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

While the foregoing has been with reference to a particular embodiment of the disclosure, it will be appreciated by those skilled in the art that changes in this embodiment may be made without departing from the principles and spirit of the disclosure, the scope of which is defined by the appended claims

1. A simulation system, comprising:
a computer system having a processor and a plurality of lines of computer code executed by the processor so that the processor is configured to:
receive a first task probability density function that indicates a range of probabilities for a characteristic of the first task;
receive a second task probability density function that indicates a range of probabilities for a characteristic of the second task;
select an operation that combines the probability density function of the first and second tasks;
assign a random number to the characteristics of the first and second tasks, respectively and generate a random characteristic for each of the first and second tasks;
perform an addition operation of the random characteristics of the first and second tasks if the first task occurs in series with the second task;
perform a merge operation of the random characteristics of first and second tasks if the first task occurs in parallel with the second task; and
generate an output probability density function as a result of the selected operation that represents a simulation of a completion characteristic of the first and second tasks.

2. The system of claim 1, wherein the processor is further configured to select a number of iterations during which the selected operation is performed.

3. The system of claim 2, wherein the processor is further configured to a select new random number for the first task characteristic and the second task characteristic for each iteration.

4. The system of claim 1, wherein the first task probability density function and the second task probability density function are part of an integrated master schedule.

5. The system of claim 1, wherein the processor is further configured to change the second task probability density function to a next task probability density function if the first and second tasks are not related.

6. The system of claim 1 further comprising the processor being further configured to receive a third task probability density function that indicates a range of durations that the third task occurs and a probability associated with each duration of the third task, wherein the probability density function of the first task and the second task each indicate a range of durations that the first and second task respectively occur and a probability associated with each duration and wherein the first task, second task and the third task are parallel and wherein the processor is further configured to perform a merge operation of the durations of the first task, the second task and the third task.

7. The system of claim 1 further comprising the processor being further configured to perform a mathematical operation between the tasks that each have a probability density function.

8. The system of claim 7, wherein the mathematical operation further comprises subtraction, multiplication or division.

9. The system of claim 1 further comprising the processor being configured to merge the probability density functions of the first and second tasks using convolution.

10. The system of claim 1, wherein the characteristic for each task comprises one of a duration for each task and one of a risk and a return for each task.

11. The A simulation method performed on a computer system having a processor and memory and a plurality of lines of computer code, the method comprising:
receiving a first task probability density function that indicates a range of probabilities for a characteristic of the first task;
receiving a second task probability density function that indicates a range of probabilities for a characteristic of the second task;
selecting, by the computer system, an operation that combines the probability density function of the first and second tasks; A simulation method performed on a computer system having a processor and memory and a plurality of lines of computer code, the method comprising:
receiving a first task probability density function that indicates a range of probabilities for a characteristic of the first task;
receiving a second task probability density function that indicates a range of probabilities for a characteristic of the second task;
selecting, by the computer system, an operation that combines the probability density function of the first and second tasks;
assigning a random number to the characteristic of the first and second tasks,
respectively and generate a random characteristic for each of the first and second tasks;
performing an addition operation of the random characteristics of the first and second tasks if the first task occurs in series with the second task;
performing a merge operation of the random characteristics of first and second tasks if the first task occurs in parallel with the second task; and
generating an output probability density function as a result of the selected operation that represents a simulation of a completion characteristics of the first and second tasks.

12. The method of claim 11 further comprising selecting a number of iterations during which the selected operation is performed.

13. The method of claim 12 further comprising selecting a new random number for the first task characteristic and the second task characteristic for each iteration.

14. The method of claim 11, wherein the first task probability density function and the second task probability density function are part of an integrated master schedule.

15. The method of claim 11 further comprising changing the second task probability density function to a next task probability density function if the first and second tasks are not related.

16. The method of claim 11 further comprising receiving a third task probability density function that indicates a range of durations that the third task occurs and a probability associated with each duration of the third task, wherein the probability density function of the first task and the second task each indicate a range of durations that the first and second task respectively occur and a probability associated with each duration and wherein the first task, the second task and the third task are parallel and further comprising performing, the computer system, a merge operation of the durations of the first task, the second task and the third task.

17. The method of claim 11 further comprising performing a mathematical operation between the tasks that each have a probability density function.

18. The method of claim 17, wherein the mathematical operation further comprises subtraction, multiplication or division.

19. The method of claim 11 further comprising merge, using the computer system, the probability density functions of the first and second tasks using convolution.

20. The method of claim 11, wherein the characteristic for each task comprises one of a duration for each task and one of a risk and a return for each task.

21-42. (canceled)
